(19) United States
(12) Patent Application Publication
(10) Pub. No.: US 2004/0162761 A1
(43) Pub. Date: Aug. 19, 2004

(54) Rewards program for customers of internet service resellers

(76) Inventor: Mark R. Comer, Highland, UT (US)

Correspondence Address: Angus C. Fox, III, 4093 N. Imperial Way, Provo, UT, 84604-5386, US

(21) Appl. No.: 10/779,344

(22) Filed: Feb. 12, 2004

Related U.S. Application Data
(60) Provisional application No. 60/446,873, filed on Feb. 12, 2003.

(51) Int. Cl. G06F 17/60

(52) U.S. Cl. 705/14

(57) ABSTRACT

A method of doing business whereby a Wholesale Internet Service Provider (WISP) provides a turnkey Internet access system that enables another organization or entity, such as a charity, church, university, service organization or business, to resell Internet access services on a private-label, retail basis, thereby creating the impression that the organization or entity (a Retail Internet Service Provider, or RISP) is providing the Internet access service, while in reality, the service is being provided by the WISP. The RISP markets and takes subscriptions for the Internet access service. The program is combined with a rewards program that provides reward points to end user subscribers which may be redeemed at an online store run by the RISP. The RISP receives a revenue stream that is equal to the revenue collected from its Internet subscribers minus overhead and costs paid to the WISP for the provision of service.

### RELATED U.S. APPLICATION DATA

This application has a priority date based on Provisional Patent Application No. 60/446,873 filed Feb. 12, 2003.

### BACKGROUND OF THE INVENTION

1. Field of the Invention

This invention relates to methods of doing business and, more specifically, to a method of providing rewards to customers of Internet service resellers who purchase Internet access from Internet service wholesalers.

2. Description of the Prior Art

Internet access is provided to individuals and organizations by countless Internet service providers (ISPs). Some of the better known ISPs are America On Line (AOL), Microsoft Network (MSN), Comcast, Prodigy, Earthlink, Verizon, Qwest, Insight, Mediacom, Directway, NetZero, Juno, Joi, SBC Yahoo, Access-4-Free, Netcom, and Big Zoo. Monthly fees for unlimited dial-up service range from $5.99 for Big Zoo to $22.00 for AOL. An interesting prepaid usage plan has been developed by Personal Internet Card and Communications, Inc. For about $30, a block of 2100 minutes of dial-up service can be purchased. Alternatively, 400 minutes of access through a toll-free number dial-up are available for the same price. Broadband Internet monthly service fees are typically about double the cost of the highest-cost dial-up services. Assuming that the companies charging less than $10 per month for unlimited dial-up access are running businesses rather than charities, one could reasonably assume that the Internet access businesses of AOL, MSN and Earthlink are making more than a healthy profit. It is no secret that the expensive name brand ISPs, such as AOL, MSN and Earthlink, are steadily losing customers to the lower-cost ISPs. It seems that web surfers generally have very little loyalty to their ISPs. Demand appears to be cost and feature driven, rather than brand driven. Internet access is rapidly becoming a commodity.

### SUMMARY OF THE INVENTION

An object of the present invention is to provide a mechanism for organizations which typically engender feelings of strong brand loyalty—such as universities, churches, and service organizations—to capitalize on that brand loyalty by acting as a branded Internet service provider (ISP) to its clientele, thereby generating an ongoing revenue stream.

A further object of the present invention is to increase the loyalty of consumers to their branded ISPs by providing monetary incentives to the consumers, in the form of a reward point credit account, which can be negotiated for goods and/or services at a store managed by the branded Internet service provider.

The present invention is a method of doing business whereby a Wholesale Internet Service Provider (WISP) provides a turnkey Internet access system that enables another organization or entity to resell Internet access services on a private-label, retail basis, thereby creating the impression that the organization or entity (a Retail Internet Service Provider, or RISP) is providing the Internet access service, while in reality, the service is being provided by the WISP. The RISP markets and takes subscriptions for the Internet access service, yet the requested service is provided transparently by the WISP. When accessing the Internet through the program, each individual end user subscriber is provided with a start-up, or portal, page which identifies the participating organization as the Internet Service Provider. The organization, in effect, becomes the perceived Internet service provider (ISP) to its own end user clients and, by encouraging its clients to switch their ISP service, the organization will receive a portion of the monthly revenues for the provision of those services. The business method of the present invention is equally well suited to non-profit and for-profit organizations, whether public or private. Such organizations may include, without limitation, churches and other religious groups, colleges and universities, service organizations, political organizations, fraternal organizations, and charities. The clientele of any organization which participates in the business method of the present invention are provided by the WISP with Internet service that is private-labeled to identify that organization. Thus, rather than participating in a wealth transfer to major ISP companies, such as AOL, MSN and Earthlink, individual consumers can now opt to subscribe to Internet service access from an organization in which they may have a personal interest and/or an affiliation. By subscribing to Internet service access through the organization, the clientele effectively provide the organization with an ongoing revenue stream equal to total subscription revenue minus the cost of the wholesale service provided by the WISP and the overhead incurred by the organization in the retailing of the Internet service access.

The business method may be an integral component of the participating organization's fundraising efforts. In the case where the organization is a church or charity, a portion of the monthly Internet access service fee paid by a client of the organization can be considered a charitable contribution from the standpoint of Federal taxation. Thus, revenue accruing to the RISP in excess of its costs will be retained as earned income, contributions or donations, depending on the tax status of the organization.

The business method of the present invention does not require that Internet access service be priced above industry standards. Without becoming a charity itself, the participating organization can be competitive in the marketplace by pricing its Internet access service anywhere between its actual net costs and the average retail monthly price of similar service. Of course, by reducing its own portion of net revenue, a participating organization can increase the incentive for individuals to switch to its branded Internet access service.

The business method is also operated in conjunction with a rewards program, with a portion of ISP revenue in excess of related costs being allocated as reward points to the end user clientele. This aspect of the invention further distinguishes it from other programs where the provision of Internet access service has been previously used in conjunction with fundraising programs. By reselling Internet service access obtained from the WISP and providing a rewards to its clientele, an organization is able to attract clients to its retail Internet service access business by virtue of two factors: the first being a pre-existing affinity and/or loyalty to the participating organization; the second being the attraction of the rewards program.

As an integral part of the business method of the present invention, each organization which contracts with the WISP for the resale of its Internet access service will be provided with a rewards program that is specifically tailored to the need of that organization. Rewards points are earned by each end user subscriber by virtue of his/her monthly payment for Internet access services. Typically, one reward point is earned for each dollar paid as monthly Internet service subscription fees. The WISP tracks the reward points which have been earned by each individual on a database running on one of its server computer systems. These rewards points are displayed on the subscriber's individual portal page. The WISP also maintains an online store/redemption center for each RISP organization, which is entered through the RISP-branded portal page. The RISP organization determines which products and/or services will be offered at its online store/redemption center and also sets the number of reward points that must be redeemed by one of its end user subscribers for each product or service. In this manner, reward points earned by an end user subscriber of the RISP organization may be redeemed. It is assumed that the RISP organization will purchase the products and services offered at its online store/redemption center wholesale, and that those same products and services will be redeemed or sold at their retail value. By setting a reward point value, the RISP organization can determine the amount of its net revenue from its RISP business allocated to the rewards program and the amount allocated to profit. Of course, the online store/redemptiion center can be operated as a profit center. In addition to providing goods and services for redemption with reward points, the store can also sell the same goods and services for actual dollar currency by accepting payment by credit card or through online payment services such as Paypal, Verisign and Propay.

### BRIEF DESCRIPTION OF THE DRAWINGS

FIG. 1 is a block diagram which shows the Internet connection path for an end user subscriber participating in the business method of the present invention; and

FIG. 2 is a revenue flow chart for the business method of the present invention.

### DETAILED DESCRIPTION OF THE INVENTION

The business method of the present invention is designed to provide various fundraising opportunities for contracting organizations that resell, to individual subscribers, Internet access service provided by a wholesale Internet Service Provider (WISP). The WISP provides a turnkey Internet access service system that typically includes multiple server computer systems, multiple routers and a fiber optic connection to the Worldwide Web. This equipment and connection enables other organizations and entities to resell Internet access services provided by the WISP on a private-label, retail basis, thereby creating the impression that the organization or entity (a Retail Internet Service Provider, or RISP) is providing the Internet access service. In reality, the service is being provided transparently by the WISP. The RISP markets and takes subscriptions for the Internet access service. When accessing the Internet through the program, each individual end user subscriber is provided with a start-up, or portal, page which identifies the participating reseller organization, or RISP, as the Internet Service Provider. The organization, in effect, becomes the perceived Internet service provider (ISP) to its own end user clients and, by encouraging its clients to switch their ISP service, the organization will receive a portion of the monthly revenues for the provision of those services. The business method of the present invention is ideally suited to organizations to which tax-deductible donation may be made, including, without limitation, churches and other religious groups, colleges and universities, service organizations, certain political organizations, and charities. Each end user subscriber can get a charitable tax deduction for at least part of his or her monthly Internet access service fees, and if that deduction is less than $250, no supporting documentation is required. The business method of the present invention also works well for fraternal organizations and any other business or organizational entity which engenders intense brand or organizational loyalty and pride.

The subscribing clientele of a reseller organization which participates in the business method of the present invention are provided by the WISP with Internet service that is private-labeled to identify the reseller organization. Recurring subscription fees paid by end user subscribers for the Internet access service are collected by the WISP. Revenue in excess of the wholesale cost of providing the Internet access service are transferred to the reseller organization. The excess revenue can be retained as profit or applied in full or in part to a rewards program designed to increase brand and organizational loyalty even more.

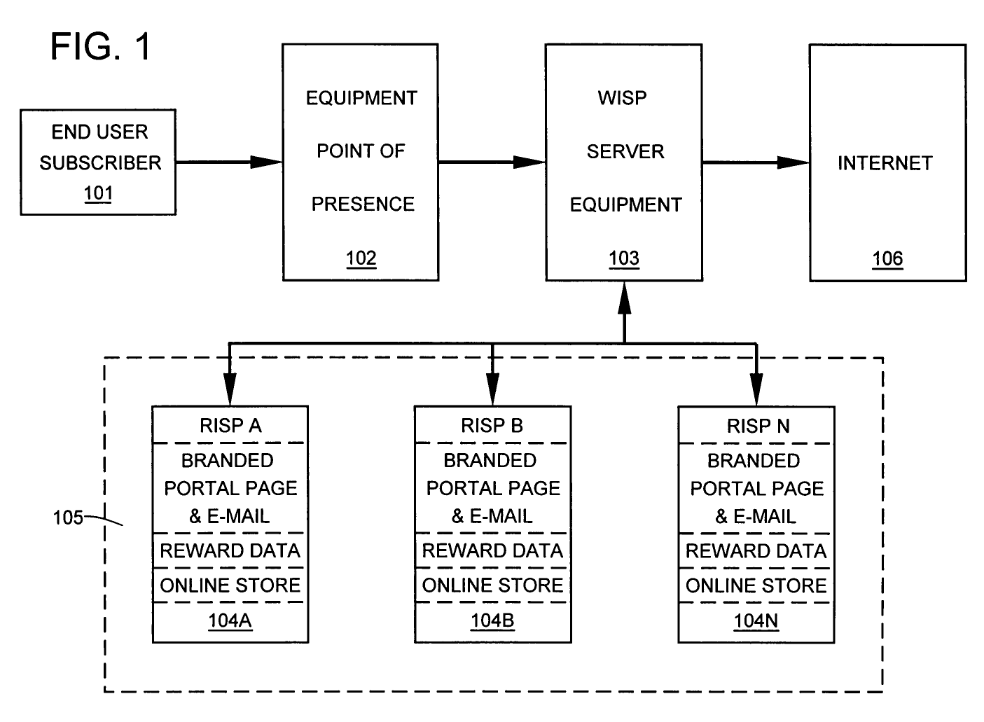

Referring now to FIG. 1, an end user subscriber 101 accesses the Internet using the present invention by connecting to the WISP server equipment 103 via equipment point of presence 102, which may be a personal computer, a terminal, or wireless link. Upon inputting a user name and password, the server equipment identifies the end user subscriber as belonging to a particular organizational group and fetches a startup portal page from the appropriate database 104A, 104B . . . 104N on mass storage unit 105. With the portal page loaded on the end user subscriber's screen, connection is made to the Internet 106. If the end user subscriber accesses his e-mail account, a branded e-mail organizer is fetched from the appropriate database, along with any stored e-mail messages.

For a preferred embodiment of the invention, the startup portal page includes a direct link between the end user subscriber and his affiliated reseller organization. The startup portal page may also contain organization-specific information, updates, links to customer service and other related resources. In this environment, the reseller organization, whether it be a charity, a church, university, fraternal organization, or service organization, controls the content of marketing or solicitations received by the end user subscriber. Each portal page, allows the reseller organization control over the dissemination of any permission-based marketing and fundraising materials received by each end user subscriber. By creating the custom startup portal page and becoming the virtual provider of the end user subscriber's Internet access, the reseller organization has created a captive marketing audience. End users subscribers, on the other hand, will no longer be bombarded by random solicitations which are sent from the existing Internet Service Providers (ISPs) such as MSN, AOL & Earthlink. The brand loyalty to the reseller organization and its services and/or products is also increased as a result of the direct communication link that is created between the end user subscriber and the reseller organization. Each end user subscriber is in direct contact with the reseller organization every time he or she turns on the computer and goes online.

The business method of the present invention is also designed to increase Internet service provider loyalty. It is extremely difficult for typical ISP companies to convince customers of other services to switch to their service. Internet access service has become a commodity. That is, most ISP competitors provide identical products and services at nearly identical prices. In short, as there is little or nothing to distinguish one ISP from another, there is little or no incentive for existing customers to switch to other ISP companies.

The business method of the present invention provides a rewards program which a reseller organization may implement on behalf of its end user subscribers. The rewards program provides a healthy incentive for and end user to switch ISPs. In addition, because of the unique relationship that end users have with the targeted organizations, it is far less likely that they will be lured away to another ISP. The rewards program simply enhances brand loyalty.

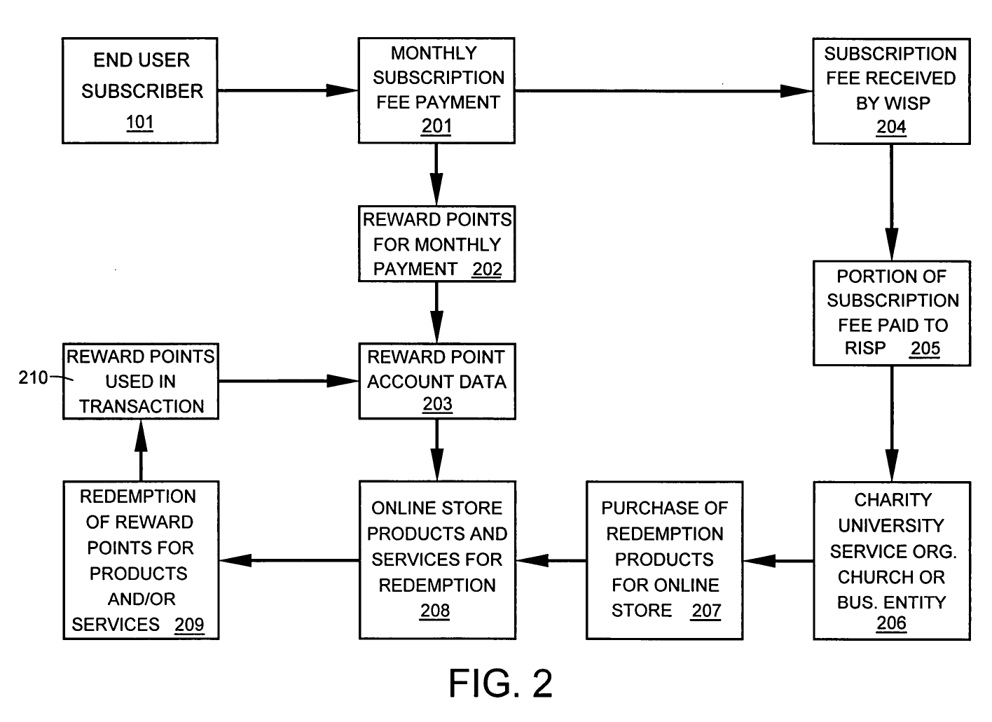

Referring now to FIG. 2, the rewards program is described in detail. The end user subscriber 101 remits a month subscription fee payment 102 that is received by the Wholesale Internet Service Provider (WISP) 204. The end user subscriber is awarded reward points 202 based on the amount of his payment, which are added to those in his existing account 203. Revenue received by the WISP 204 in excess of the wholesale cost of the Internet access services provided is transferred to the reseller organization 206. The reseller organization 206 may retain the excess revenue as profits or may choose to utilize all or part thereof to purchase redemption products 207 to stock an online store 208. From his startup portal page, the end user subscriber 101 can access the online store 208 and effect a redemption 209 of his accrued reward points for products and/or services. The reward points 210 used in the redemption transaction are deducted from the end user subscriber's account 203.

As a part of the branded Internet access service product, each end user subscriber receives his own email account branded with the name of his reseller organization. This in and of itself is another form of passive marketing and will further disseminate marketing and other information to the organization's network.

Inclusion of the end user subscriber in online discussions can further the direction, purpose and involvement in the causes of the reseller organization. This creates a non-invasive method of contact for the organization, and allows ongoing direct communication regarding current needs, additional donations, etc.

When applied to for-profit businesses, the method of the present invention presents an opportunity for those businesses to resell internet access through their existing market and distribution channels, with revenues in excess of costs be used to provide incentives to clients, customers, and referrals to initialize service on their branded Internet access service. A multi-level organization may be easily implemented using the business method and distributing the profits in the various down lines.

The number of reward points made available to each end user subscriber under the rewards program for purchases at an online store is determined by the monthly access fees paid by the subscriber. The number of points required to purchase specific products or services offered by the reseller organization through the online store is determined ahead of time based upon the underlying costs of the products or services being offered, and the profit margin the organization desires to realize. The online store is particularly effective when the reseller organization is the provider of the goods and services, as the margins would typically be higher than if the products were purchased from third parties. These margins create what shall be called a multiple value or ratio based on the comparison between the retail value of products or services and the actual hard cost of creating the products or services. This multiple is then applied to each dollar received from the end user subscriber, and translated into reward points. The larger the margin, the better the possibility of having a larger multiple (the largest multiple possible is 1; i.e., $1=1 reward point). The WISP assists the reseller organization in the calculation of this multiple as it applies to specific products and/or services being offered at the online store.

The business method of the present invention is beneficial to reseller organization, as it changes the way they and their customer bases and related entities connect with the internet, such as:

Each end user subscriber who switches his Internet access service to a reseller organization is provided a startup portal page that automatically comes up each time the individual goes online. A direct communication link between the end user subscriber and the reseller organization is thus created. The end user subscriber no longer need connect to the Internet via an unaffiliated third party. Provision of a custom startup portal page can also provide product and service information, updates, links to customer service, company news and events and other sites, company news and events. The organization, in effect, controls the content received by the end user subscriber. Each portal site enables the reseller organization to control the dissemination of permission-based marketing materials received by each end user subscriber via the portal page they see at startup.

The rewards program enables a reseller organization to provide discounts or credits by allowing an end user subscriber to purchase its own products and services. Each dollar paid for internet access, which was previously paid to some other ISP, is now being applied, at a specific ratio or multiple (which is unique to each company) to the products and/or services of the reseller organization. The rewards program, the brand loyalty that the end user subscriber already feels, and any other benefits/products or services that may be packaged as a switch-over/starter kit, provides ample incentive to persuade the end user subscriber to switch ISP providers. With a rewards program marketing campaign, special discounts, contests, promotions and other unique marketing concepts will be created which are tailored to suit the needs of each reseller organization.

E-mail accounts for all of the end user subscribers, employees, customers, clients, and contacts of each reseller organization are branded in the name of the reseller organization. This in and of itself is another form of passive marketing, and will further disseminate marketing and other information to the organization's immediate network of end users. A reseller organization has the option to provide information to its end users via email at any point in time, thus creating a captive audience of highly qualified, interested clients.

Inclusion of an end user subscriber in online discussions can further the direction, purpose and involvement in the specific business initiatives. This creates a non-invasive method of contact for the reseller organization, and allows ongoing direct communication regarding current needs, additional revenue streams, etc.

Although only several embodiments of the invention have been disclosed herein, it will be obvious to those having ordinary skill in the art that changes and modifications may be made thereto without departing from the spirit and scope of the invention as hereinafter claimed.

What is claimed is:

1. A method of providing Internet service access, said method including the steps of:
establishing a business entity which provides wholesale Internet access service;
establishing a contractual relationship with at least one reseller organization that desires to resell the wholesale Internet access service provided by the business entity, said at least one reseller organization agreeing to a certain price structure for the provision of the wholesale Internet access service;
recruiting end user subscribers who desire to obtain Internet service access and who agree to pay a recurring fee for such access, said recruiting being performed by said at least one reseller organization or its agents;
collecting the fees from end user subscribers, said collecting being performed by said business entity; and
paying the reseller organization the difference between the amount collected from end user subscribers and the cost of the wholesale Internet access service.

2. The method of claim 1, which further comprises the step of providing a rewards program, whereby end user subscriber is awarded reward points for each recurring payment, the number of reward points awarded being based on the amount received from the end user subscriber.

3. The method of claim 2, which further comprises the step of providing an online store associated with said at least one reseller organization, said online store having an inventory of goods and/or services which can be purchased by an end user subscriber who subscribes to the Internet access service through said at least one reseller organization, said purchase being effected through the redemption of accrued reward points.

4. The method of claim 1, wherein said at least one reseller organization is selected from the group consisting of charities, service organizations, universities, churches, and for-profit businesses.

5. The method of claim 1, wherein said business entity provides a portal page to each end user subscriber when he logs on to the Internet that is branded to identify the reseller organization through which he subscribes to the Internet access service.

6. The method of claim 1, wherein said business entity provides e-mail service to each end user subscriber that is branded to identify the reseller organization through which he subscribes to the Internet access service.

7. The method of claim 3, wherein each online store is managed by its respective reseller organization, each of said online stores being a software program and an associated database, both of which are provided by the business entity.

8. The method of claim 5, wherein each portal page provides a link to a website of the associated reseller organization, a link to an online store associated with the subscriber's reseller organization, as well as a link to the end user subscriber's reward point data.

9. The method of claim 5, wherein the reseller organization controls the dissemination of permission marketing ads and fundraising materials on each end user subscriber's portal page.

10. The method of claim 5, wherein an end user subscriber's portal page provides links to message boards which deal with issues associated with the reseller organization.

11. A method of providing Internet access service, said method including the steps of:
establishing a business entity having multiple server computers, multiple routers and a fiber-optic connection to the world-wide web, all for providing wholesale Internet access service;
establishing a contractual relationship with each of multiple reseller organizations, each of which desires to resell the wholesale Internet access service provided by the business entity to third-party subscribers, each reseller organization agreeing to a certain price structure for the provision of the wholesale Internet access service;
recruiting end user subscribers who desire to obtain Internet service access and who agree to pay a recurring fee for such access, said recruiting being performed each reseller organization or its agents;
collecting the fees from end user subscribers, said collecting being performed by said business entity;
paying the reseller organization the difference between the amount collected from end user subscribers and the cost of the wholesale Internet access service;
providing a rewards program, whereby end user subscribers are awarded reward points for each recurring payment made, the number of reward points awarded being a function of the recurring payment amount; and
providing an online store associated with each rewards program, said online store having an inventory of goods and/or services which can be purchased by an end user subscriber through the redemption of accrued reward points.

12. The method of claim 11, wherein each reseller organization is selected from the group consisting of charities, service organizations, universities, churches, and for-profit businesses.

13. The method of claim 11, wherein said business entity provides a portal page to each end user subscriber when he logs on to the Internet that is branded to identify the reseller organization through which he subscribes to the Internet access service.

14. The method of claim 11, wherein said business entity provides e-mail service to each end user subscriber that is branded to identify the reseller organization through which he subscribes to the Internet access service.

15. The method of claim 11, wherein each online store is managed by its respective reseller organization, each of said online stores being a software program and an associated database, both of which are provided by the business entity.

16. The method of claim 13, wherein each portal page provides a link to a website of the associated reseller organization, a link to an online store associated with the subscriber's reseller organization, as well as a link to the end user subscriber's reward point data.

17. The method of claim 13, wherein the reseller organization controls the dissemination of permission marketing ads and fundraising materials on each end user subscriber's portal page.

18. The method of claim 13, wherein an end user subscriber's portal page provides links to message boards which deal with issues associated with the reseller organization.
